(19) United States
(12) Patent Application Publication
(10) Pub. No.: US 2018/0114043 A1
(43) Pub. Date: Apr. 26, 2018

(54) SENSOR STRIP AND CODE RECOGNITION DEVICE USING THE SAME

(71) Applicant: OSANG HEALTHCARE CO., LTD., Anyang-si (KR)

(72) Inventor: Keun Young KIM, Seoul (KR)

(21) Appl. No.: 15/792,433

(22) Filed: Oct. 24, 2017

(30) Foreign Application Priority Data
Oct. 24, 2016 (KR) 10-2016-0138675

(51) Int. Cl. G06K 7/10; G06K 7/14; G06K 19/06

(52) U.S. Cl. CPC G06K 7/10564; G06K 19/06037; G06K 7/1417

(57) ABSTRACT

The present invention relates to a sensor strip and a code recognition device. The sensor strip includes electrode patterns printed with conductive ink according to a preset code. The code recognition device includes a sensor strip, and a code recognition module configured to recognize the electrode patterns printed on the sensor strip and recognize the code assigned to the sensor strip.

### CROSS-REFERENCE TO RELATED APPLICATION

This application claims priority to and the benefit of Korean Patent Application No. 10-2016-0138675, filed on Oct. 24, 2016, the disclosure of which is incorporated herein by reference in its entirety.

### BACKGROUND

### 1. Field of the Invention

The present invention relates to a sensor strip and a code recognition device using the same, and more particularly, to a sensor strip and a code recognition device for recognizing code printed on a surface of a sensor strip to compensate for a sensing measurement deviation.

### 2. Discussion of Related Art

These days, the number of people suffering from diabetes is rapidly increasing due to increased high calorie, high fat, and high protein diets resulting from westernization of eating habits, and environmental factors including stress, lack of exercise, and the like. Following this trend, technology for diagnosing the condition of one's health is increasing in importance

As a method of diagnosing illness or a person's health status, a blood glucose measuring device for simple examination for illness or health status through a blood sample is widely being used.

Here, the blood glucose measuring device is intended to measure a glucose concentration in blood and displays a value of a blood glucose level when blood is applied to a sensor strip and the sensor strip is inserted into the blood glucose measuring device.

Before the advent of such a blood glucose measuring device, it was necessary to visit a hospital in person to check the condition of one's own health, but now it is possible to check one's own health through a simple method of using a blood glucose measuring device with a body fluid sample.

A sensor strip is intended to quantitatively and qualitatively analyze a sample taken from a human body. A sample from a human body is taken and applied to the sensor strip, and the sensor strip is inserted into a blood glucose measuring device. However, the sensor strip has a sensing measurement deviation due to features of a manufacturing process thereof, and a unique code for compensating for the sensing measurement deviation is assigned to the sensor strip. Accordingly, the blood glucose measuring device compensates a sample analysis result for the measurement deviation through the code.

However, up to now there has been a problem in that the code, when implemented as a barcode, a color strip, and the like, may not be recognized due to contamination of the sensor.

A related art of the present invention is disclosed in Korean Patent No. 10-1493152 (Feb. 6, 2015) “Blood Glucose Meter.”

### SUMMARY OF THE INVENTION

The present invention is directed to providing a sensor strip on which a code is printed with conductive ink so that individual electrode patterns may be sequentially recognized when the sensor strip is inserted into a blood glucose (sugar) measuring device, and a code recognition device using the sensor strip.

According to an aspect of the present invention, there is provided a sensor strip including: a base; and electrode patterns printed on the base with conductive ink according to a preset code.

In the present invention, the electrode patterns may be matched to individual bits of the code.

In the present invention, the electrode patterns may have different sizes and shapes according to individual bits of the code.

According to another aspect of the present invention, there is provided a code recognition device including: a sensor strip including electrode patterns printed with conductive ink according to a preset code; and a code recognition module configured to recognize the electrode patterns printed on the sensor strip and recognize the code assigned to the sensor strip.

In the present invention, the electrode patterns may be matched to individual bits of the code.

In the present invention, the electrode patterns may have different sizes and shapes according to individual bits of the code.

In the present invention, the code recognition module may apply power to the electrode patterns and recognize the code on the basis of resistance values measured from the electrode patterns.

In the present invention, the code recognition module may include: a power supply configured to supply the power to the electrode patterns; and a code detector configured to, when the power is applied from the power supply to the electrode patterns, detect the resistance values changed through the electrode patterns and detect the code on the basis of the detected resistance values.

In the present invention, the code recognition module may further include an electrode pattern recognizer configured to detect the resistance values changed by the power applied from the power supply and recognize whether there are electrode patterns on the basis of the detected resistance values, and the code detector may detect a resistance value changed by the power applied from the power supply every time each of the electrode patterns is recognized by the electrode pattern recognizer and detect a bit matched to each electrode pattern on the basis of the detected resistance value.

In the present invention, the code detector may detect each bit every time each of the electrode patterns is recognized by the electrode pattern recognizer, and may detect the code by sequentially combining the individual bits in order of detection.

In the present invention, the code recognition module may recognize the code corresponding to the electrode patterns by radiating light to the electrode patterns.

In the present invention, the code recognition module may include: a light emitter configured to emit light; a light receiver configured to receive light; and a code detector configured to detect the code by detecting individual bits matched to the electrode patterns according to whether the light emitted from the light emitter is received by the light receiver.

In the present invention, the code detector may detect the individual bits of the electrode patterns and detect the code by sequentially combining the individual bits in order of detection.

In the present invention, the code recognition module may include: a metal detector configured to detect a metal component in the conductive ink of the electrode patterns by generating a magnetic field; and a code detector configured to detect the code on the basis of a detection result of the metal detector.

In the present invention, every time a metal component is detected by the metal detector, the code detector may detect each bit matched to the electrode patterns on the basis of an amount of the metal component detected by the metal detector, and may detect the code by sequentially combining the individual bits in order of detection.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a sensor strip according to an exemplary embodiment of the present invention;

FIG. 2 is an example diagram of electrode patterns printed on a sensor strip according to an exemplary embodiment of the present invention;

FIG. 3 is a block diagram of a code recognition device according to an exemplary embodiment of the present invention;

FIG. 4 is a block diagram of an example of a code recognition module according to an exemplary embodiment of the present invention;

FIG. 5 is a diagram illustrating a code recognition method employing the code recognition module of FIG. 4;

FIG. 6 is a block diagram of another example of a code recognition module according to an exemplary embodiment of the present invention;

FIG. 7 is a diagram illustrating a code recognition method employing the code recognition module of FIG. 6; and

FIG. 8 is a block diagram of still another example of a code recognition module according to an exemplary embodiment of the present invention.

### DETAILED DESCRIPTION OF EXEMPLARY EMBODIMENTS

Hereinafter, a sensor strip and a code recognition device according to exemplary embodiments of the present invention will be described in detail with reference to the accompanying drawings. Herein, the drawings may be exaggerated in thicknesses of lines or sizes of components for the sake of convenience and clarity in description. Terms which will be used below are defined in consideration of functionality in the present invention, which may vary according to an intention of a user or an operator or a usual practice. Therefore, definitions thereof should be made on the basis of the overall contents of this specification.

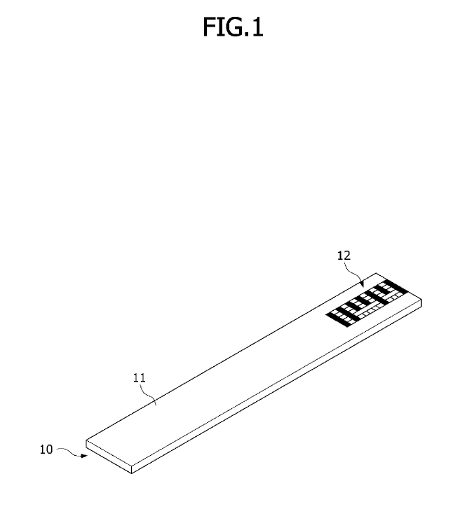

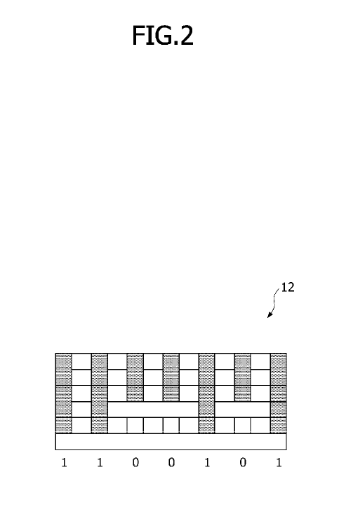

FIG. 1 is a perspective view of a sensor strip according to an exemplary embodiment of the present invention, and FIG. 2 is an example diagram of electrode patterns printed on a sensor strip according to an exemplary embodiment of the present invention.

Referring to FIG. 1, a sensor strip 10 according to an exemplary embodiment of the present invention is used to analyze a sample taken from a human body.

The sensor strip 10 is intended to analyze a sample taken from a human body. A sample is applied to the sensor strip 10, and the sensor strip 10 is inserted into a blood glucose measuring device through an insertion hole (not shown).

The sensor strip 10 has a sensing measurement deviation due to features of a manufacturing process thereof, and a unique code for compensating for the sensing measurement deviation is assigned to the sensor strip 10. Accordingly, the blood glucose measuring device compensates a sample analysis result for the measurement deviation by using the code.

The sensor strip 10 according to an exemplary embodiment of the present invention includes a base 11 and electrode patterns 12 printed on the base with conductive ink according to the code.

The code is composed of a plurality of bits, and the individual bits are combined to generate the single code. Here, each bit is “1” or “0,” and these bits are combined to form the single code.

Referring to FIG. 2, each of the electrode patterns 12 is matched to each bit of the code, and a plurality of electrode patterns 12 are formed according to the number of bits. Since an electrode pattern 12 is related to a “1” or “0” as mentioned above, the electrode pattern 12 varies in size and shape according to a matched bit.

As an example, an electrode pattern 12 matched to a bit “1” is longer than an electrode pattern 12 matched to a bit “0.”

The electrode patterns 12 are formed in a longitudinal direction of the base 11 in order of the bits of the code, and have different lengths in a transverse direction of the base 11 depending on matched bits.

In particular, the bits of the code are sequentially disposed as the electrode patterns 12 in an insertion direction so that the individual bits of the code are sequentially recognized when the sensor strip 10 is inserted. Therefore, when the sensor strip 10 is inserted into the blood glucose measuring device, the individual bits are sequentially recognized in the insertion direction.

As an example, the code shown in FIG. 2 becomes “1010011” in the insertion direction.

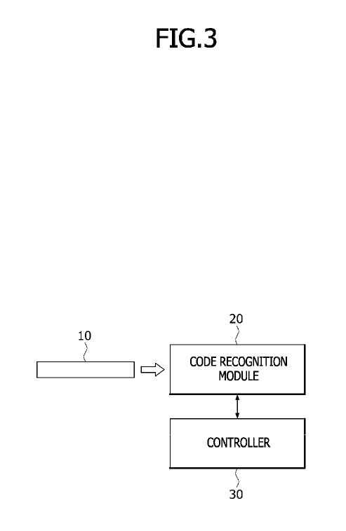

FIG. 3 is a block diagram of a code recognition device according to an exemplary embodiment of the present invention.

Referring to FIG. 3, a code recognition device according to an exemplary embodiment of the present invention includes the sensor strip 10, a code recognition module 20, and a controller 30.

Since the sensor strip 10 is the same as illustrated in FIGS. 1 and 2, the detailed description thereof will be omitted here.

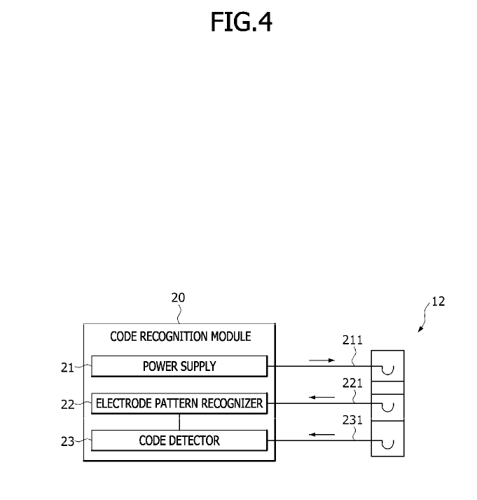

The code recognition module 20 recognizes electrode patterns 12 printed on the sensor strip 10 and recognizes a code assigned to the sensor strip 10 through the recognized electrode patterns 12. The code recognition module 20 may detect the electrode patterns 12 in a manner involving contact, a manner not involving contact, or the like. This will be described in detail with reference to FIGS. 4 to 8.

When the sensor strip 10 is inserted into an insertion hole, the controller 30 controls the code recognition module 20 so that the code recognition module 20 recognizes the code assigned to the sensor strip 10.

Also, the controller 30 acquires an accurate measurement result by compensating for a sensing measurement deviation of the sensor strip 10 with the code recognized by the code recognition module 20.

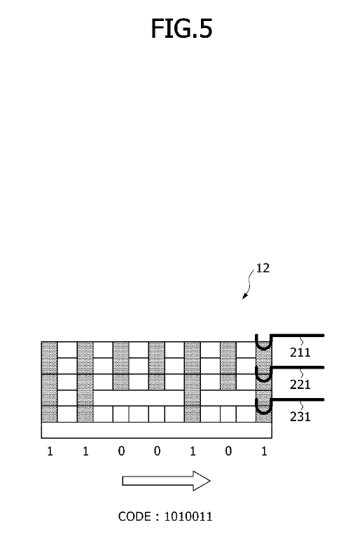

FIG. 4 is a block diagram of an example of a code recognition module according to an exemplary embodiment of the present invention, and FIG. 5 is a diagram illustrating a code recognition method employing the code recognition module of FIG. 4.

When the sensor strip 10 is inserted through the insertion hole, the code recognition module 20 recognizes the electrode patterns 12 printed on the sensor strip 10 and recognizes a code assigned to the sensor strip 10 through the recognized electrode patterns 12.

Referring to FIG. 4, the code recognition module 20 includes a power supply 21, an electrode pattern recognizer 22, and a code detector 23.

The power supply 21 is electrically connected to the electrode patterns 12 via a power supply pin 211 and applies power to the electrode patterns 12 via the power supply pin 211.

The electrode pattern recognizer 22 is electrically connected to the electrode patterns 12 via an electrode pattern recognition pin 221, detects resistance values changed by the power applied from the power supply 21, and recognizes whether the electrode patterns 12 are present on the basis of the detected resistance values.

The electrode pattern recognition pin 221 is disposed apart from the power supply pin 211 and recognizes the electrode patterns 12 regardless of sizes of the electrode patterns 12.

When the power is supplied from the power supply 21, the electrode pattern recognizer 22 detects a voltage drop across a resistance between the power supply pin 211 and the electrode pattern recognition pin 221. Accordingly, the electrode pattern recognizer 22 detects resistance values on the basis of the voltage and recognizes whether electrode patterns 12 are present according to whether corresponding resistance values are detected.

The code detector 23 is electrically connected to the electrode patterns 12 via a code detection pin 231. When the power is supplied from the power supply 21 to the electrode patterns 12, the code detector 23 detects resistance values which are changed through the electrode patterns 12 and detects a code on the basis of the detected resistance values.

When the power is supplied from the power supply 21, the code detector 23 detects voltage drops across a resistance between the power supply pin 211 and the code detection pin 231. Accordingly, the code detector 23 detects resistance values on the basis of the detected voltages and detects the code on the basis of voltage or current differences caused by differences in the detected resistance values.

In particular, every time an electrode pattern 12 is recognized by the electrode pattern recognizer 22, the code detector 23 recognizes that the electrode pattern 12 is present. Thus, the code detector 23 sequentially detects individual bits matched to the individual electrode patterns 12 in order of detection.

In other words, when a user inserts the sensor strip 10 via the insertion hole, the power supply 21 supplies power to the electrode patterns 12 according to a control signal of the controller 30. When the sensor strip 10 is inserted, the electrode patterns 12 are sequentially recognized by the electrode pattern recognizer 22, and also the code detector 23 recognizes the bits matched to the individual electrode patterns by sequentially detecting resistance values which are changed by the power supplied from the power supply 21, and detects the code by sequentially combining these bits in order of detection.

Referring to FIG. 5, when the user inserts the sensor strip 10 into the insertion hole, the power supply 21 supplies the power to the electrode patterns 12, and the electrode pattern recognizer 22 sequentially recognizes the electrode patterns 12 on the basis of changes in resistance value caused by the power supplied from the power supply 21.

Also, the code detector 23 detects the bits matched to the individual electrode patterns 12 by sequentially detecting voltage or current differences caused by a resistance value changed by the power applied from the power supply 23. In other words, the code detector 23 detects the bits in order of “1,” “0,” “1,” “0,” “0,” “1,” and “1,” and sequentially combines the bits “1,” “0,” “1,” “0,” “0,” “1,” and “1” in order of detection to finally acquire the code “1010011.”

In this exemplary embodiment, an example of acquiring a code on the basis of digital values has been described. However, the technical scope of the present invention is not limited thereto and also includes a case in which a code is acquired on the basis of analog values corresponding to measured voltages or currents.

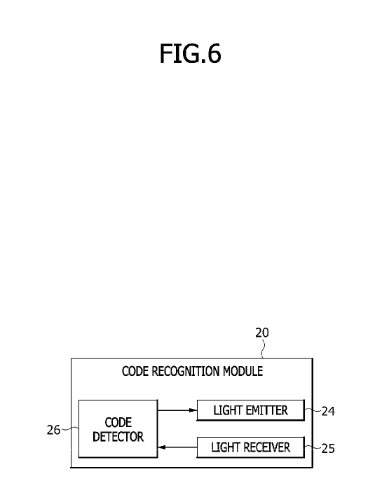

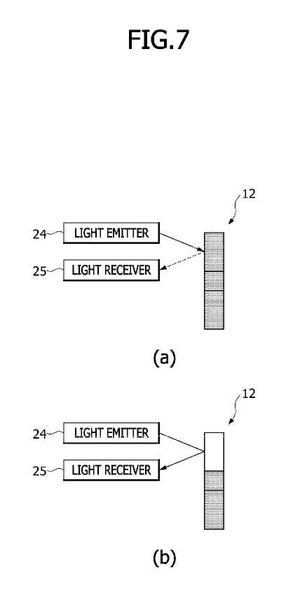

FIG. 6 is a block diagram of another example of a code recognition module according to an exemplary embodiment of the present invention, and FIG. 7 is a diagram illustrating a code recognition method employing the code recognition module of FIG. 6.

Referring to FIG. 6, the code recognition module 20 includes a light emitter 24, a light receiver 25, and a code detector 26.

The light emitter 24 emits light toward the electrode patterns 12. The light emitted from the light emitter 24 may be absorbed by the electrode patterns 12 or reflected by the base 11.

As described above, the electrode patterns 12 are formed of conductive ink and thus may absorb light. While an electrode pattern 12 matched to the bit “1” is formed to be relatively long, an electrode pattern 12 matched to the bit “0” is formed to be relatively short.

When the light emitter 24 emits light to one side of the electrode patterns 12, the light emitted from the light emitter 24 may be absorbed or reflected according to whether a corresponding electrode pattern 12 is an electrode pattern matched to the bit “1” or “0.”

When the electrode pattern 12 is one matched to the bit “1,” the light emitted from the light emitter 24 is absorbed by the electrode pattern 12, and when the electrode pattern 12 is one matched to the bit “0,” the light emitted from the light emitter 24 is reflected by the base 11.

The light receiver 25 receives the light which is emitted from the light emitter 24 and reflected by the base 11.

The code detector 26 recognizes the individual bits matched to the electrode patterns 12 according to whether the light emitted from the light emitter 24 is received by the light receiver 25, and then detects the code by combining the recognized bits.

In other words, when the sensor strip 10 is inserted into the insertion hole, the code detector 26 controls the light emitter 24 so that the light emitter 24 emits light.

Subsequently, the code detector 26 recognizes a bit of a corresponding electrode pattern 12 as “1” when the light emitted from the light emitter 24 is not received by the light receiver 25 as shown in (a) of FIG. 7, and recognizes a bit of a corresponding electrode pattern 12 as “0” when the light emitted from the light emitter 24 is received by the light receiver 25 as shown in (b) of FIG. 7.

Subsequently, the code detector 26 detects the code by sequentially combining the individual bits recognized as described above in order of recognition.

In addition, a device for determining whether electrode patterns 12 are present may be further provided. For example, the light emitter and the light receiver may be additionally provided and used to determine whether the electrode patterns 12 are present as described above.

For example, the code detector 26 may recognize that there is an electrode pattern 12 when light emitted from the light emitter is not received by the light receiver, and recognize that there is not an electrode pattern 12 when the light emitted from the light emitter is received by the light receiver.

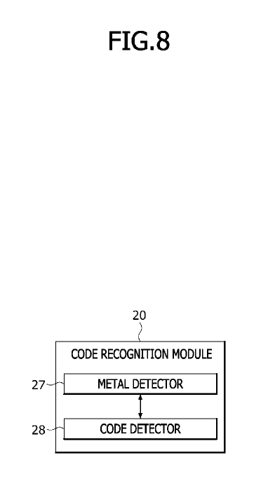

FIG. 8 is a block diagram of still another example of a code recognition module according to an exemplary embodiment of the present invention.

Referring to FIG. 8, the code recognition module 20 includes a metal detector 27 and a code detector 28.

The metal detector 27 generates a magnetic field and detects a metal component in the conductive ink of the electrode patterns 12.

The code detector 28 detects a code on the basis of a detection result of the metal detector 27.

The electrode patterns 12 are formed of conductive ink as mentioned above. While an electrode pattern 12 matched to the bit “1” is formed to be relatively long, an electrode pattern 12 matched to the bit “0” is formed to be relatively short. Here, the electrode pattern 12 matched to the bit “1” has the same width as the electrode pattern 12 matched to the bit “0.”

Therefore, the electrode pattern 12 matched to the bit “1” has a larger amount of metal component than the electrode pattern 12 matched to the bit “0.” For this reason, when the metal component of the conductive ink is detected by the metal detector 27, the amount of detected metal component varies according to whether a corresponding electrode pattern 12 is one matched to the bit “1” or the bit “0.”

Consequently, the code detector 28 recognizes a bit of a corresponding electrode pattern 12 as “1” or “0” on the basis of the amount of metal component detected by the metal detector 27. In this case, the code detector 28 may compare the amounts of metal component and recognize bits according to the amounts, or may set ranges for the bit “1” and the bit “0” and recognize a bit of an electrode pattern 12 according to whether the amount of detected metal component falls into the set ranges.

In other words, every time the metal component is detected by the metal detector 27, the code detector 28 detects each bit of the electrode patterns 12 on the basis of the amount of metal component and detects a code by sequentially combining the detected individual bits.

As described above, when the sensor strip 10 on which a code is printed with conductive ink is inserted into a blood glucose measuring device, a device for recognizing a code of the sensor strip 10 according to an exemplary embodiment of the present invention causes individual electrode patterns to be sequentially recognized so that a user can easily and conveniently use the blood glucose measuring device.

According to an exemplary embodiment of the present invention, since a code is printed with conductive ink on the sensor strip 10, it is possible to reduce the manufacturing cost of the sensor strip 10.

Meanwhile, in this exemplary embodiment, a code for compensating for a sensing measurement deviation of a blood glucose measuring device has been described as an example, and an operation of detecting the code of a sensor strip and compensating for a sensing measurement deviation of a blood glucose measuring device with the code of the sensor strip has been described as an example.

However, the technical scope of the present invention is not limited thereto.

In other words, the code is not limited to a code for compensating for a sensing measurement deviation of a blood glucose measuring device and may vary according to the type or features of the sensor or the like. For example, the code may correspond to a lot, a range, an error, a warning, and the like.

Further, the technical scope of the present invention encompasses all of various devices for detecting the code and compensating a result value with the detected code.

Although exemplary embodiments of the present invention have been described in detail above, those of ordinary skill in the art to which the present invention pertains will appreciate that various modifications may be made without departing from the scope of the present invention. Therefore, the scope of the present invention is to be determined by the following claims and their equivalents, and is not limited by the described exemplary embodiments.

What is claimed is:

1. A sensor strip comprising:
a base; and
electrode patterns printed on the base with conductive ink according to a preset code.

2. The sensor strip of claim 1, wherein the electrode patterns are matched to individual bits of the code.

3. The sensor strip of claim 1, wherein the electrode patterns have different sizes and shapes according to individual bits of the code.

4. A code recognition device comprising:
a sensor strip including electrode patterns printed with conductive ink according to a preset code; and
a code recognition module configured to recognize the electrode patterns printed on the sensor strip and recognize the code assigned to the sensor strip.

5. The code recognition device of claim 4, wherein the electrode patterns are matched to individual bits of the code.

6. The code recognition device of claim 4, wherein the electrode patterns have different sizes and shapes according to individual bits of the code.

7. The code recognition device of claim 4, wherein the code recognition module applies power to the electrode patterns and recognizes the code based on resistance values measured from the electrode patterns.

8. The code recognition device of claim 7, wherein the code recognition module comprises:
a power supply configured to supply the power to the electrode patterns; and
a code detector configured to, when the power is applied from the power supply to the electrode patterns, detect the resistance values changed through the electrode patterns and detect the code based on the detected resistance values.

9. The code recognition device of claim 8, wherein the code recognition module further comprises an electrode pattern recognizer configured to detect the resistance values changed by the power applied from the power supply and recognize whether there are electrode patterns based on the detected resistance values, and the code detector detects a resistance value changed by the power applied from the power supply every time each of the electrode patterns is recognized by the electrode pattern recognizer and detects a bit matched to each electrode pattern based on the detected resistance value.

10. The code recognition device of claim 9, wherein the code detector detects each bit every time each of the electrode patterns is recognized by the electrode pattern recognizer, and detects the code by sequentially combining the individual bits in order of detection.

11. The code recognition device of claim 4, wherein the code recognition module recognizes the code corresponding to the electrode patterns by radiating light to the electrode patterns.

12. The code recognition device of claim 11, wherein the code recognition module comprises:
a light emitter configured to emit light;
a light receiver configured to receive light; and
a code detector configured to detect the code by detecting individual bits matched to the electrode patterns according to whether the light emitted from the light emitter is received by the light receiver.

13. The code recognition device of claim 12, wherein the code detector detects the individual bits of the electrode patterns and detects the code by sequentially combining the individual bits in order of detection.

14. The code recognition device of claim 4, wherein the code recognition module comprises:
a metal detector configured to detect a metal component in the conductive ink of the electrode patterns by generating a magnetic field; and
a code detector configured to detect the code based on a detection result of the metal detector.

15. The code recognition device of claim 14, wherein every time the metal component is detected by the metal detector, the code detector detects each bit matched to the electrode patterns based on an amount of metal component detected by the metal detector, and detects the code by sequentially combining the individual bits in order of detection.
